(19) United States
(12) Patent Application Publication
(10) Pub. No.: US 2009/0272211 A1
(43) Pub. Date: Nov. 5, 2009

(54) MULTI-GROUP TRANSMISSION OF A MOTOR VEHICLE

(75) Inventors: Rayk HOFFMANN, Friedrichshafen (DE); Alan DITTRICH, Konstanz (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/434,080

(22) Filed: May 1, 2009

(30) Foreign Application Priority Data
May 5, 2008 (DE) 10 2008 001 537.7

(51) Int. Cl. F16H 61/70; F16H 3/08; F16D 28/00; F16H 3/38

(52) U.S. Cl. 74/325; 74/745; 192/84.9; 74/340

(57) ABSTRACT

A multi-group transmission of a motor vehicle which includes at least two transmission groups arranged in a drivetrain and a way for supporting traction force during gearshifts such that traction-force gearshifts are maintained with improved shifting comfort at comparatively low cost, little design effort and compact installation space demands. At least one electromagnetic clutch is a change-under-load unit by which, bypassing the force flow of at least one main group made as a gear-change transmission, an active connection can be formed between a driveshaft and a main transmission shaft or a transmission output shaft. During a gearshift operation, an active connection is temporarily made between a driveshaft and a main transmission shaft or a transmission output shaft by way of at least one electromagnetic clutch designed as a change-under-load unit.

This application claims priority from German patent application serial no. 10 2008 001 537.7 filed May 5, 2008.

### FIELD OF THE INVENTION

The invention concerns a multi-group transmission of a motor vehicle and a method for operating a multi-group transmission of a motor vehicle.

### BACKGROUND OF THE INVENTION

Multi-group transmissions consist of two or more transmission groups, usually arranged in series, by combining which a large number of gears can be produced. Increasingly, they are designed as automated gearshift transmissions consisting, for example of an input group, a main group and a downstream range group. Such transmissions are used in particular in utility vehicles since they provide an especially fine gradation of gears, for example with 12 or 16 gears, and are highly efficient. For a smaller number of gears configurations with only a main group and an input group or a main group and a range group are also possible. Furthermore, compared with manual gearshift transmissions they are characterized by high operating comfort and, compared with automatic transmissions, their production and operating costs are particularly economical.

By virtue of their structure conventional multi-group gearshift transmissions, like all manual or automated gearshift transmissions not shifted under load, undergo a traction force interruption during gearshifts since the flow of force from the drive motor is always interrupted by disengaging a clutch in order to disengage the engaged gear without load, to synchronize the transmission and the drive motor in a neutral position to a connection speed, and then to engage the target gear. Since the vehicle is rolling during the traction force interruption, undesired speed increases or speed decreases can occur. In addition the fuel consumption can increase. Whereas with passenger motor vehicles the traction force interruption, which affects the driving dynamics, is as a rule perceived only as annoying, for example during upshifts in a driving style of sporty orientation, in the case of medium-weight or heavy utility vehicles the driving speed can be reduced to the point where an upshift is made impossible and, on uphill stretches, undesired downshifts, creep-driving or even additional starting operations may be necessary.

From DE 10 2006 024 370 A1 by the present applicant a traction-force-supported automated multi-group transmission with a splitter group as its input transmission, a main group as its basic transmission and a range group as its output or downstream transmission is known. The structure of this known multi-group transmission with its input group and the main group enables a direct gear to be engaged as an intermediate gear during a gear change. For this, a direct connection is temporarily formed between an input shaft of the input transmission and a main shaft of the main transmission by means of a change-under-load clutch. This renders the main transmission and the splitter group free from load, so that the engaged gear can be disengaged, the transmission synchronized and the target gear engaged, during all of which the starting clutch remains engaged. The change-under-load clutch transmits the motor torque to the transmission output, and a dynamic torque that is released during a speed reduction between the original and target gears is used to a large extent to compensate the traction force interruption. The change-under-load clutch can be positioned between the input transmission and the main transmission or between the starting clutch and the input transmission. The gear ratio of the intermediate gear is determined by the direct connection of the input shaft to the main shaft. A shift in the range group is not necessarily traction-force-supported without adopting other measures.

Moreover, from DE 198 44 783 C1 a method for shifting a gear-change transmission with interlock-type gearwheel clutches is known in which, by means of a gear-synchronizing transmission integrated in the speed-change transmission, optionally by means of a gear stage with ratio i>1 or a gear stage with ratio i<1 a drive connection can be formed between a transmission input shaft and a transmission output shaft. A respective friction clutch is associated with each of the gear stages, which are used during a gearshift operation to adapt the speed of the input shaft to the respective synchronous speed. By controlling the frictional connection between the input and output shafts and/or the drive motor, the speed of the input shaft and the torque variation at the output shaft during the gear change are influenced. A frictional starting element arranged between the drive motor and the input shaft remains engaged during the gearshift operation. Thus, the gearshift is comparable to a change-under-load. The method can be used, by virtue of a suitable alternating use of the frictional connections via one or the other gear stage of the synchronizing transmission, for upshifts or downshifts in traction and thrust operation.

From EP 1 096 172 A2 an automated change-under-load transmission with unsynchronized gearshift clutches is known. Again, two friction clutches are provided for synchronization. A common flywheel is arranged as a clutch input component between a crankshaft of the drive motor and a transmission input shaft. One synchronization clutch is coupled to the lowest gear stage and used for thrust gearshifts and as a starting element. The other synchronization clutch is coupled to the highest gear stage and used for traction gearshifts. The synchronization clutches are connected on one side via the thrust or traction gears to a transmission output shaft and on the other side via the clutch input component to the transmission input shaft. Synchronization during a gearshift operation, i.e. equalization of the speed of the transmission input shaft with the speed of the gearset of the target gear, takes place by engaging or disengaging the thrust or traction synchronization clutch. During a traction shift the synchronization clutches and the gearshift clutches are actuated in a shift sequence which ensures the transmission of a drive torque to the transmission output shaft, so that the gearshift takes place with no interruption of the traction force. In contrast to the known, traction-force-supported, sequentially shifted double clutch transmissions, this transmission also enables shifts with gear intervals over more than one step to be carried out.

The two last-mentioned publications each describe a change-speed transmission with change-under-load characteristics. The synchronization clutches described therein, which maintain a torque flow to the drive output, are respectively coupled to the lowest and highest gear stage of the change-speed transmission. However, this solution cannot be easily transferred to a multi-group transmission with a number of transmission groups arranged one after another in the flow of force, and its shift sequence.

### SUMMARY OF THE INVENTION

Against this background the purpose of the present invention is to indicate a multi-group transmission and a method for operating a multi-group transmission which, with comparatively small demands in terms of cost, design and construction effort, and structural space, enable traction-force-maintaining gearshifts to be carried out with further improved shifting comfort.

The invention is based on the recognition that with the help of electromagnetic clutches, gears, gear constants and/or gear ranges of individual groups of an automated multi-group transmission can be shifted under load or bridged by means of additional gearsets through power-branched intermediate gears in the force flow, in order to compensate or avoid traction force interruptions in shift operations of these groups, so that with such a transmission greater operational comfort is achieved without actuating a starting element during the gear change or even when a separate starting element is omitted entirely.

Accordingly, the invention starts from a multi-group transmission of a motor vehicle, with at least two transmission groups arranged in the drivetrain, in which means are provided for supporting the traction force during gearshift operations. To achieve the stated objective the invention also provides that at least one electromagnetic clutch made as a change-under-load means is provided, by virtue of which, while bypassing the force flow of at least a main group made as a gear-change transmission, an active connection can be formed between a driveshaft and a main transmission shaft or a transmission output shaft.

A gearshift is understood to mean a shift operation in which an original gear is disengaged and a target gear is engaged, including also the special case in which the target gear is the same as the original gear so that no gear ratio change takes place. An electromagnetic clutch is understood to be a clutch that can be actuated by the magnetic force of an electromagnet.

In addition the invention starts from a method for operating a multi-group transmission of a motor vehicle, with at least two transmission groups arranged in a drivetrain, in which traction force supporting means are activated during a gearshift operation. In relation to the method, the stated objective is achieved in that at least by means of an electromagnetic clutch made as a change-under-load means, an active connection can be temporarily formed or maintained between a driveshaft and a main transmission shaft or a transmission output shaft.

According to the invention, particularly in automated multi-group transmissions with a splitter group having two gear constants as the upstream transmission, a three- or four-gear main group as a basic transmission of countershaft design and a range group of planetary structure as its downstream transmission, for example in a heavy utility vehicle, electromagnetic clutches can be used to good advantage for supporting the traction force. They are noted in particular for their accurate controllability, quick response time and compact structure. Furthermore no additional or large-size oil pump, as sometimes needed with hydraulic clutches for supporting the traction force, is required for actuating the clutch.

Preferably a transmission of this type is designed with two countershafts, so that in the embodiments described below—when “one” or “at least one” countershaft is mentioned—the sense of this should be extended to two countershafts. Correspondingly, the power is branched via two countershafts.

According to the invention, during a gearshift an electromagnetic clutch can engage an additional gearset as an intermediate gear, this intermediate-gear gearset being driven by at least one countershaft. In this case the electromagnetic clutch advantageously comprises a pot-like rotor on the drive input side, which encloses an axially displaceable, disk-shaped armature on the drive output side and an electric energizing magnet, such that the rotor mounted to rotate on a shaft on the drive output side is connected in a rotationally fixed manner at its outer wall to a loose wheel of the intermediate-gear gearset and has frictional means on its inner wall on the clutch input side.

The armature and clutch output side frictional means are arranged fixed on the drive output shaft and the frictional means can move axially relative to one another, so that depending on the current in the energizing magnet or an embedded energizing coil, axial displacement of the armature under the action of magnetic force can bring the frictional means into active contact with one another so that the electromagnetic clutch can transfer torque in a slipping or in a friction-locked mode. An end face of the energizing magnet can function as a pressure plate of the clutch packet, and in that case to increase the contact pressure force a ball ramp device known per se can advantageously be provided. In principle, other electromagnetically actuated clutch structures are also possible.

The intermediate-gear gearset with the electromagnetic clutch can be arranged downstream from the main group, and a fixed wheel fitted in a rotationally fixed manner on the countershaft is in that case engaged with a loose wheel mounted to rotate on a main transmission shaft, such that the loose wheel can be connected in a rotationally fixed manner by means of the electromagnetic clutch to the said main transmission shaft on the drive output side of the main group. This arrangement is structurally particularly compact.

Also advantageous is an arrangement in which, by virtue of axially extended countershafts, the intermediate-gear gearset with the electromagnetic clutch are arranged downstream from the range group, and in that case a fixed wheel mounted rotationally fixed on the countershaft is engaged with a loose wheel mounted to rotate on the transmission output shaft, the said wheel being able to be connected rotationally fixed to the transmission output shaft by means of the electromagnetic clutch. In this case the traction force support also includes a shifting of the range group during the gear change, regardless of whether or not the range group is designed to be able to change under load or whether or not the main transmission shaft is directly connected to the transmission output shaft.

Furthermore it can be provided that the splitter group has two gear constants, a further respective electromagnetic clutch being associated with each gear constant, by means of which the gear constants can be shifted under load. The electromagnetic clutches replace the usual synchronized shift mechanisms for engaging the gear constants. In this way, on the one hand a traction force interruption while shifting between the gear constants is avoided. On the other hand the electromagnetic clutches of the splitter group can also be used as starting elements so that a separate, conventional starting element can be omitted, this additionally having a cost, space and weight saving effect.

The shift-under-load function and the starting function can advantageously be obtained if the electromagnetic clutch of the first gear constant on the motor side, has an armature arranged so that it can be axially displaced on the driveshaft and a rotor surrounding the armature, which is connected in a rotationally fixed manner to a loose wheel of the first gear constant and arranged together with the wheel to rotate on the driveshaft, and an energizing magnet, while the electromagnetic clutch of the second gear constant, on the transmission side, has an axially displaceable armature arranged on the driveshaft and a rotor surrounding the armature, which is connected in a rotationally fixed manner to a loose wheel of the second gear constant and arranged together with the wheel to rotate on the driveshaft, and an energizing magnet, such that on the driveshaft respective frictional means arranged on the clutch input side, and on the rotors respective frictional means arranged on the clutch output side, can be brought into mutual frictional engagement, so that the loose wheels can be connected, selectively and alternately, in a rotationally fixed manner to the driveshaft. For this, the electromagnetic clutches can be engaged or disengaged one after the other or with an overlap.

In a preferred embodiment of the method according to the invention it is provided that in a gearshift involving a shift operation within the main group, the intermediate-gear gearset is engaged as an intermediate gear by means of the associated electromagnetic clutch, whereby the intermediate gear, bypassing the force flow of the main group, forms an active connection between the driveshaft and the main transmission shaft or the transmission output shaft. This enables traction upshifts or downshifts to be carried out with no interruption of the traction force. By engaging the intermediate gear the main transmission is rendered free from load and can therefore be shifted. The gearshift clutch of the original gear in the main transmission preferably remains engaged until the shift to the target gear has been made. Rather, the electromagnetic clutch on the additional, intermediate-gear gearset supports the motor torque at the drive output in its slipping condition, while the motor speed is adapted to the target gear selected.

Since by means of an appropriate intermediate gear the rotating masses to be synchronized can be braked, the transmission brake usually provided for braking those masses during upshift processes can be omitted, whereby further costs, space and weight are saved. Only for a shift process is the gearshift clutch of the original gear engaged in the main transmission disengaged, and the desired target gear is engaged when the synchronous speed has been reached. Thereafter the electromagnetic clutch is disengaged again and the force flow is then transmitted via the new gear.

Such traction-force-supported gear changes are also possible with gear intervals covering two or more gear steps. Since the drivetrain remains under load throughout the gear change by virtue of the intermediate gear, fluctuations and jerky shifts are also reduced, which results in an additional improvement of the shifting comfort.

In further preferred version of the method according to the invention it is provided that during a gear change involving a shift operation within the splitter group, a shift is carried out by means of the associated electromagnetic clutches between the gear constants, such that an active connection is preserved between the driveshaft and the main transmission shaft or the transmission output shaft. Accordingly, gear changes in which shifting only occurs between the gear constants are carried out directly under load by means of the electromagnetic clutches of the splitter group, so that in this case an engagement of an intermediate gear can be omitted.

### BRIEF DESCRIPTION OF THE DRAWINGS

To clarify the invention the description of a drawing with two example embodiments is attached. The drawings show:

FIG. 1: Transmission layout of a multi-group transmission of a motor vehicle with electromagnetic clutches for traction-force-supported shift operations

FIG. 2: A second embodiment of a multi-group transmission with electromagnetic clutches

FIG. 3: Schematic representation of an electromagnetic clutch for engaging an intermediate gear, drawn on a larger scale, and

FIG. 4: Two more electromagnetic clutches for shifting a splitter transmission, drawn on a larger scale.

### DETAILED DESCRIPTION OF THE PREFERRED EMBODIMENTS

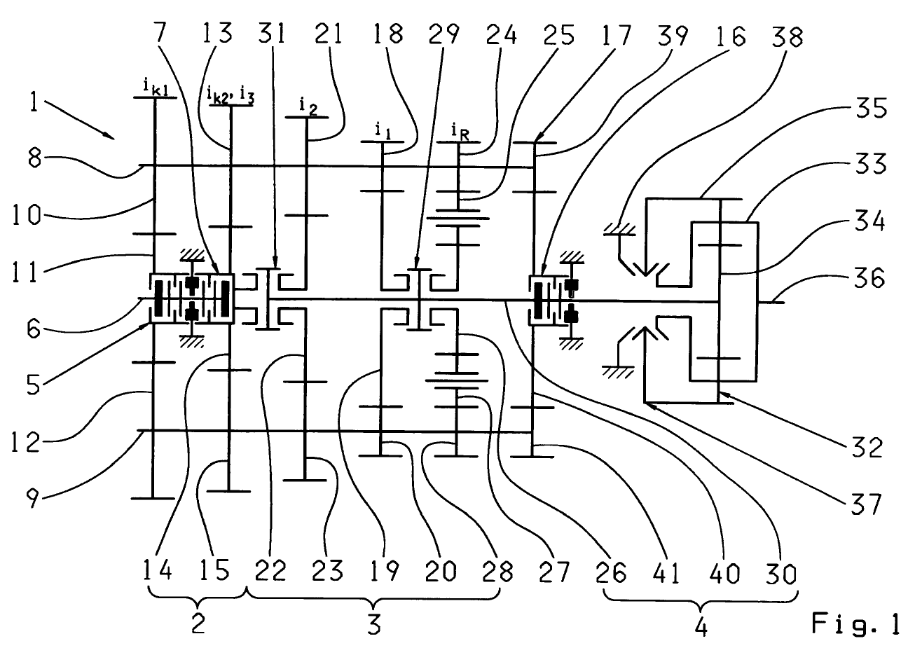

FIG. 1 shows an automated multi-group transmission designed as a dual-countershaft transmission 1, with two parallel rotating countershafts 8, 9 and three transmission groups 2, 3 and 4 arranged one after another, as can be provided for example in the drivetrain of a truck. Such a transmission, as such, i.e. without traction force support, is known in particular from the ZF-AS Tronic series, and with traction-force-supporting direct gear engagement from DE 10 2006 024 370 A1 by the present applicant, mentioned earlier.

The first transmission group 2, located on the motor side, is formed as a two-gear splitter group. The second, central transmission group 3 consists of a three-gear main or basic transmission. The third, output-side transmission group 4 is a two-gear range group arranged on the downstream side.

The splitter group 2 has two gear constants iₖ₁, iₖ₂, each comprising a fixed wheel 10, 12 or 13, 15 respectively arranged rotationally fixed on the first countershaft 8 and on the second countershaft 9, these wheels meshing with a respective loose wheel 11 or 14. To engage the gear constants iₖ₁, iₖ₂, in each case an electromagnetic clutch 5 or 7, to be described in detail later, is provided, by means of which the loose wheels can optionally be connected rotationally fixed to a driveshaft 6 of a drive motor (not shown). By means of these electromagnetic clutches 5, 7 the splitter group can be shifted under load, i.e. the gear constants iₖ₁, iₖ₂ can be switched between without interruption of the drive input. The electromagnetic clutches can also be used as starting elements and are therefore correspondingly sized.

The main transmission 3 has three forward gears i₁, i₂ and i₃ and a reverse gear i_{R}. The 1^{st} and 2^{nd} gears each have two fixed wheels 18, 20 or 21, 23 and a loose wheel 19 or 22. The 3^{rd} gear is produced in combination with the second gear constant iₖ₂, of the splitter transmission 2. The reverse gear comprises two fixed wheels 24, 28, a loose wheel 26 and two rotating intermediate wheels, 25, 27 for reversing the rotation direction, which mesh on one side with the respective associated fixed wheel 24 or 28 and on the other side with the loose wheel 26. To engage the 1^{st} gear and the reverse gear a shift device 29 with shifting claws is provided, by means of which the associated loose wheel 19 or 26 can selectively be connected rotationally fixed to a main transmission shaft 30. To engage the 2^{nd} gear and the 3^{rd} gear a claw-type shift device 31 is provided, by means of which the respective associated loose wheel 14 or 22 can selectively be coupled rotationally fixed to the main transmission shaft 30.

The downstream range transmission 4 is made as a planetary transmission.

In it, a planetary gearset 32 is guided by a planetary gear carrier 33. The planetary gearwheels mesh on one side with a central sun gear 34 and on the other side with an outer ring gear 35. The sun gear 34 is connected to the main transmission shaft 30 and the planetary gear carrier 33 to a transmission output shaft 36. To shift the range transmission 4 a shifting device 37, preferably with synchronization, is provided. In a first shift position this shifting device 37 connects the ring gear 35 to a housing 38, so that the planetary gears rotate between the ring gear 35 and the sun gear 34 and, in accordance with the gear ratio, the transmission output shaft 36 is driven by the planetary gear carrier 33 in the same direction as the main transmission shaft 30. In a second shift position the ring gear 35 is locked to the planetary gear carrier 33, so that the planetary transmission 4 and hence the transmission output shaft 36 rotate directly at the same speed as the main transmission shaft 30.

The combination of the transmission groups 2, 3 and 4 shown in the transmission layout illustrated gives a total of 2×3×2=12 gears. The force flow of the transmission 1 branches according to a shift sequence in which, beginning with the 1^{st} gear in the main transmission 3, first the splitter transmission 2 and the main transmission 3 are shifted through in alternation so that, in succession, 2×3=6 gears of a lower gear range “1^{st} to 6^{th} gears” are engaged. When the 6^{th} gear is reached the range transmission 4 is shifted over, and the main transmission 3 and splitter transmission 2 are again shifted through in alternation so that, again 2×3=6 gears, but this time in an upper gear range. “7^{th} to 12^{th} gears” are engaged. The upstream splitter group 2 also engages the reverse gear ratio i_{R} in alternation, so that in addition two reverse gears are available.

Between the main transmission 3 and the range transmission 4 is arranged an additional gearset 17 as an intermediate gear, which can be engaged by means of an electromagnetic clutch 16. The intermediate-gear gearset 17 comprises two fixed wheels 39 and 41 mounted on the countershafts 8 and 9, which are engaged with a loose wheel 40 on the main transmission shaft 30. The loose wheel 40 is connected to the electromagnetic clutch 16 by which it can be connected in a rotationally fixed manner to the main transmission shaft 30.

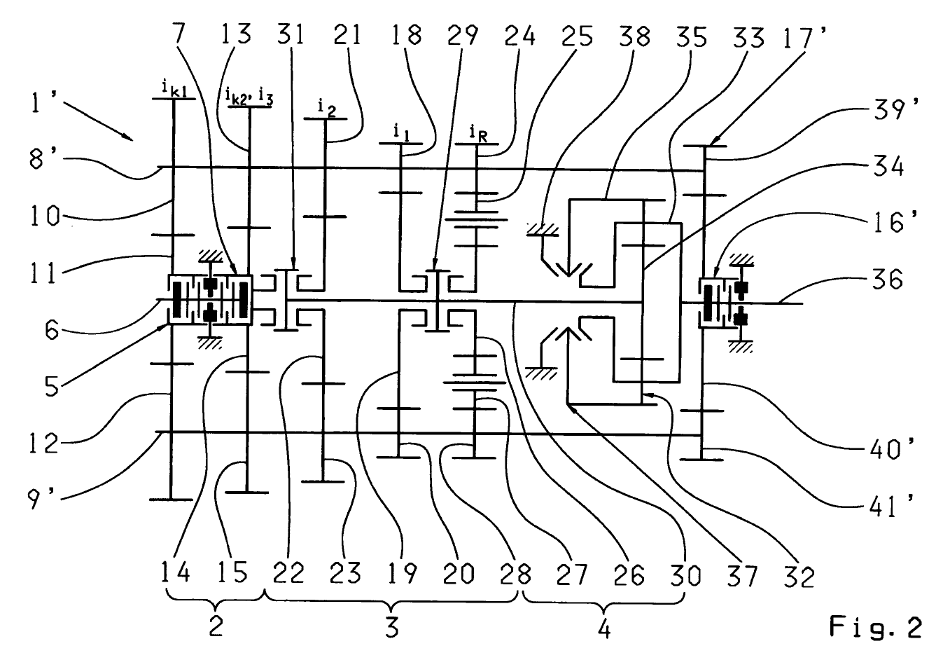

FIG. 2 shows a comparable dual-countershaft transmission 1′ with an intermediate-gear gearset 17′ and an electromagnetic clutch 16′, which are arranged behind the range group 4, i.e. directly on the transmission output. In addition the countershafts 8′, 9′, are extended axially beyond the range group 4. The intermediate-gear gearset 17′ comprises two fixed wheels 39′, 41′ mounted on the countershafts 8′, 9′, which engage with a loose wheel 40′ on the transmission output shaft 36. The loose wheel 40′ is connected to the electromagnetic clutch 16′ by means of which it can be connected in a rotationally fixed manner to the transmission output shaft 36.

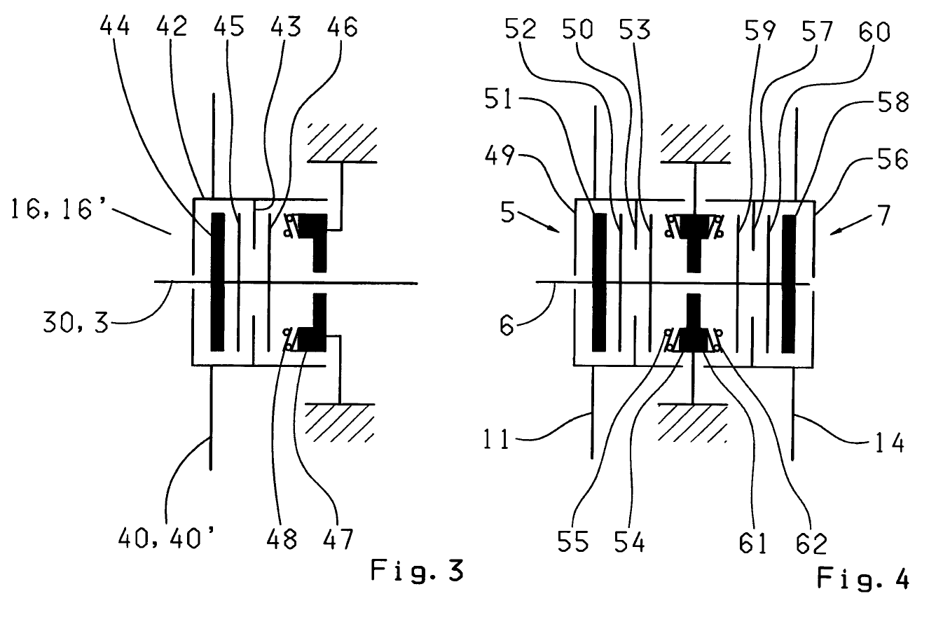

FIGS. 3 and 4 show the electromagnetic clutches 5, 7, 16, 16′ in detail. FIG. 3 shows the electromagnetic clutch 16, 16′ of the intermediate-gear gearset 17, 17′. The clutch drive, i.e. its input side, is formed as a pot-like rotor 42 connected in a rotationally fixed manner to the loose wheel 40, 40′ of the intermediate-gear gearset 17, 17′. On its inside the rotor 42 has an annular friction disk 43. The clutch output, i.e. the output side, is made as a disk-shaped armature 44 mounted in a rotationally fixed manner but able to move axially on the main transmission shaft 30 or the transmission output shaft 36. In addition, two friction disks 45, 46, are arranged so that they axially enclose the input-side friction disk 43. The corresponding friction disks 43, 45, 46 can move axially relative to one another.

Coaxially thereto is arranged a cup-shaped energizing magnet 47 with an energizing coil (not shown), with a ball ramp device 48 arranged in front of one end to increase the contact pressure. The rotor 42, armature 44, frictional means 43, 45, 46 and energizing magnet 47 together form a clutch packet, so that when current flows in the energizing magnet 47 a correspondingly strong magnetic field produces an engaged condition in which the frictional means 43, 45, 46 are locked together frictionally or, depending on the degree of engagement, they act in a slipping mode, and in the disengaged condition when the magnetic field is switched off, they are separated from one another by restoring means (not shown).

FIG. 4 shows the electromagnetic clutches 5, 7 of the splitter group 2. These are arranged in diametrically mirrored positions on the driveshaft 6 so that one clutch 5 is associated with the first gear constant iₖ₁ and the other clutch 7 with the second gear constant iₖ₂. The structure of the two splitter group clutches 5, 7 is comparable to that of the intermediate gear clutch 16, 16′, although the input and output sides are reversed, i.e. the drive input is from the driveshaft 6 and the drive output takes place via the respective loose wheel 11 or 14 of the gear constant iₖ₁ or iₖ₂.

The clutch 5 associated with the first gear constant iₖ₁ comprises a rotor 49 with output-side friction means 50 on the outside, which is connected in a rotationally fixed manner to the associated loose wheel 11, an armature 51 with associated, input-side frictional means 52, 53 and an energizing magnet 54 with a ball ramp device 55.

The clutch 7 associated with the second gear constant iₖ₂ comprises a rotor 56 with friction means 57 on the outside, which is connected in a rotationally fixed manner to the associated loose wheel 14, an armature 58 with associated, input-side frictional means 59, 60 and an energizing magnet 61 with a ball ramp device 62. On the output-side end face facing toward the main group 3 the rotor 56 is connected to the shifting device 31 of the 2^{nd} and 3^{rd} gears of the main group 3 (see FIG. 1).

A method according to the invention for operating the multi-group transmission described is based essentially on the engagement of an intermediate gear, by which the traction force of the vehicle is maintained while the main group 3 is in neutral during a gearshift operation. According to this, for example in an upshift with a shift operation in the main group 3, to engage an intermediate gear the electromagnetic clutch 16, 16′ of the intermediate-gear gearset 17, 17′ is controlled so as to operate in slipping mode. This transmits the motor torque to the main transmission shaft 30 or directly to the transmission output shaft 36.

Consequently, the main transmission 3 is freed from load. During this torque transmission by the slipping electromagnetic clutch 16, 16′ of the intermediate-gear the motor speed is reduced to a synchronous speed of a target gear. The torque released by this speed reduction is used for maintaining the traction force. The shift from the original gear to the target gear then takes place, and finally the electromagnetic clutch 16, 16′ is disengaged.

If the splitter group 2 is not involved in the gearshift operation, drive input takes place via the engaged gear constant, iₖ₁, iₖ₂ and the countershafts, 8, 8′, 9, 9′ bypassing the main group 3, to the intermediate-gear gearset 17, 17′. If, however, the shift operation involves a shift in the splitter group 2, then this takes place under load by virtue of the associated electromagnetic clutches 5, 7, i.e. in a change between the gear constants iₖ₁, iₖ₂ the torque connection to the drive motor is maintained in any case.

In the case of an intermediate-gear gearset 17′ arranged downstream from the range group 4 a shift of the gear range is automatically traction-force-supported.

On the other hand, if the intermediate-gear gearset 17 is upstream from the range group 4, additional measures may sometimes be needed for traction force support.

### List of indexes

1, 1′ Two-countershaft transmission, multi-group transmission
2 Splitter transmission
3 Main transmission
4 Range transmission
5 Electromagnetic clutch
Driveshaft
7 Electromagnetic clutch
8, 8′ Countershaft
9, 9′ Countershaft
10 Fixed wheel
11 Loose wheel
12 Fixed wheel
13 Fixed wheel
14 Loose wheel
15 Fixed wheel
16, 16′ Electromagnetic clutch
17, 17′ Intermediate-gear gearset
18 Fixed wheel
19 Loose wheel
20 Fixed wheel
21 Fixed wheel
22 Loose wheel
23 Fixed wheel
24 Fixed wheel
25 Intermediate wheel
26 Loose wheel
27 Intermediate wheel
28 Fixed wheel
29 Shift device
30 Main transmission shaft
31 Shift device
32 Planetary gearset
33 Planetary gear carrier
34 Sun gear
35 Ring gear
36 Transmission output shaft
37 Shift device
38 Housing
39, 39′ Fixed wheel
40, 40′ Loose wheel
41, 41′ Fixed wheel
42 Rotor
43 Friction means
44 Armature
45 Friction means
46 Friction means
47 Energizing magnet
48 Ball ramp device
49 Rotor
50 Friction means
51 Armature
52 Friction means
53 Friction means
54 Energizing magnet
55 Ball ramp device
56 Rotor
57 Friction means
58 Armature
59 Friction means
60 Friction means
61 Energizing magnet
62 Ball ramp device
iₖ₁ Splitter group gear constant
iₖ₂ Splitter group gear constant
i₁ Main transmission gear
i₂ Main transmission gear
i₃ Main transmission gear
i_{R} Main transmission reverse gear

1-13. (canceled)

14. A multi-group transmission (1, 1′) comprising at least two transmission groups (2, 3) arranged in a drivetrain, and means being provided for traction force support during a gearshift operation, at least one electromagnetic clutch (16, 16′) being provided as a change-under-load means by which, while bypassing a flow of force at least one main group (3) made as a gear-change transmission, an active connection is formed between a driveshaft (6) and either a main transmission shaft (30) or a transmission output shaft (36).

15. The multi-group transmission according to claim 14, wherein three automated transmission groups (2, 3,4) are provided, such that an upstream, two-gear splitter group (2) associated with a driveshaft (6) and a central, multi-gear main group (3) associated with a main transmission shaft (30) are made as countershaft transmissions with at least one countershaft (8, 8′, 9, 9′), and a downstream range group (4) made as a planetary transmission.

16. The multi-group transmission according to claim 14, wherein an intermediate gear is engaged by an intermediate-gear gearset (17, 17′) that co-operates with the electromagnetic clutch (16, 16′) and is driven by the at least one countershaft (8, 8′, 9, 9′).

17. The multi-group transmission according to claim 16, wherein the intermediate-gear gearset (17), with the electromagnetic clutch (16), is arranged downstream from the main group (3) and a fixed wheel (39, 41), mounted in a rotationally fixed manner on the at least one countershaft (8, 9), engages with a loose wheel (40) mounted to rotate on the main transmission shaft (30), the loose wheel (40) is connectable, by the electromagnetic clutch (16), in a rotationally fixed manner to the main transmission shaft (30).

18. The multi-group transmission according to claim 17, wherein the intermediate-gear gearset (17′), with the electromagnetic clutch (16′), is arranged downstream from a main group (4) and a fixed wheel (39′, 41′), mounted in a rotationally fixed manner on the at least one countershaft (8′, 9′), engages a loose wheel (40′) mounted to rotate on the transmission output shaft (36), the loose wheel (40) is connectable, by the electromagnetic clutch (16′), in a rotationally fixed manner to the transmission output shaft (36).

19. The multi-group transmission according to claim 17, wherein the electromagnetic clutch (16, 16′) comprises a cup-like rotor (42) on a drive input side which surrounds a drive-output-side and is axially displaceable, a disk-shaped armature (44) and an electric energizing magnet (47), the rotor (42) is mounted for rotation on a drive-output-side shaft (30, 36) and is connected at its outer wall rotationally fixed to the loose wheel (40, 40′) of the intermediate-gear gearset (17, 17′) and has, on an inside wall, friction means (43) on the clutch input side, the armature (44) and friction means (45, 46) on the clutch output side are connected, in a rotationally fixed manner, on the output-side shaft (30, 36), and the friction means (43, 45, 46) is axially movable relative to one another so that depending on current flowing in the energizing magnet (47), by virtue of axial displacement of the armature (44) under action of a magnetic force, the friction means (43, 45, 46) actively contact with one another and torque transmission by the electromagnetic clutch (16, 16′), in either a slipping mode or a friction-locked mode, is produced.

20. The multi-group transmission according to claim 14, wherein a splitter group (2) has two gear constants (iₖ₁, iₖ₂) and a further, electromagnetic clutch (5, 7) is associated respectively with each gear constant (iₖ₁, iₖ₂), by which the gear constants (iₖ₁, iₖ₂) are shifted under load.

21. The multi-group transmission according to claim 20, wherein the electromagnetic clutch (5) associated with a first gear constant (iₖ₁), on a motor side, comprises an armature (51) arranged so as to be axially displaced on the driveshaft (6) and, surrounding the armature (51), a rotor (49) which is connected in a rotationally fixed manner to a loose wheel (11) of the first gear constant (iₖ₁) and is arranged to rotate together with the wheel on the driveshaft (6), and an energizing magnet (54), while an electromagnetic clutch (7) associated with a second gear constant (iₖ₂), on a transmission side, comprises an armature (58) arranged to be axially displaced on the driveshaft (6) and, surrounding the armature (58), a rotor (56) which is connected in rotationally fixed manner to a loose wheel (14) of the second gear constant (iₖ₁) and is arranged to rotate together with the wheel on the driveshaft (6), and an energizing magnet (61), such that respective friction means (52, 53, 59, 60) arranged on the driveshaft (6) on the clutch input side, and respective friction means (50, 57) arranged on the rotors (49, 56) on the clutch output side are frictionally engagable, so that the loose wheels (11, 14) are selectively connectable in a rotationally fixed manner to the driveshaft (6).

22. The multi-group transmission according to claim 18, wherein the range group (4) is a change-under-load transmission.

23. The multi-group transmission according to claim 14, wherein at least one of the electromagnetic clutches (5, 7, 16, 16′) comprises a ball ramp device (48, 55, 62).

24. A method for operating a multi-group transmission (1, 1′) of a motor vehicle, with at least two transmission groups (2, 3) arranged in a drivetrain, in which traction force supporting means are activated during a gearshift operation, the method comprising the steps of either temporarily forming or maintaining an active connection between a driveshaft (6) and either a main transmission shaft (30) or a transmission output shaft (36) at least one electromagnetic clutch (5, 7, 16, 16′) made as a change-under-load means.

25. The method according to claim 24, further comprising the step of:
engaging an intermediate-gear gearset (17,17′) as an intermediate gear with an electronic clutch (16, 16′), during a gearshift with a shift operation within a main group (3) made as a gear-change transmission, such that an active connection is made between the driveshaft (6) and either the main transmission shaft (30) or the transmission output shaft (36), bypassing a flow of force at least of the main group (3), so that the main group (3) is shiftable while not under load,
disengaging an engaged original gear,
synchronizing a speed of a drive motor connected to the driveshaft (6), with the electromagnetic clutch (16, 16′) operating in slipping mode, to a connection speed of a target gear, and
engaging the target gear, when the connection speed is reached, and again disengaging the electromagnetic clutch (16, 16′).

26. The method according to claim 24, further comprising the step of shifting during a gearshift involving a shift operation within a splitter group (2) made as a gear-change transmission by means of associated electromagnetic clutches (5, 7) between gear constants (iₖ₁, iₖ₂) of the splitter group (2), such that an active connection between either the driveshaft (6) and the main transmission shaft (30) or the transmission output shaft (36) is maintained.
